(19) United States
(12) Patent Application Publication
(10) Pub. No.: US 2005/0163119 A1
(43) Pub. Date: Jul. 28, 2005

(54) Method for establishing connection between stations in wireless network

(76) Inventors: Yasuyuki Ito, Fukushima-ken (JP); Takuya Nishimura, Fukushima-ken (JP)

Correspondence Address: MORGAN & FINNEGAN, L.L.P., 3 WORLD FINANCIAL CENTER, NEW YORK, NY, 10281-2101, US

(21) Appl. No.: 11/040,737

(22) Filed: Jan. 20, 2005

(30) Foreign Application Priority Data
Jan. 20, 2004 (JP) 2004-011987

(51) Int. Cl. H04L 12/56

(52) U.S. Cl. 370/389

(57) ABSTRACT

A first station that supports both a long frame format and a short frame format becomes a parent station in order to communicate with a second station that supports only the long frame format. The first station uses two channels. The first station first transmits data in the short frame format over one of the two channels to initiate a communication with the second station, and waits for a response from the second station. Since the second station supports only a long frame format, the second station cannot recognize the frame and never responds to the first station. Thereafter, the first station transmits data in the long frame format over the other channel in order to establish a connection with the second station, and waits for a response from the second station. The second station can recognize the frame and, therefore, the connection can be established.

### BACKGROUND OF THE INVENTION

1. Field of the Invention

The present invention generally relates to a method for establishing a connection between stations in a wireless network and, in particular, to a method for establishing a connection between stations in a wireless network that is optimal for the stations to communicate with each other.

2. Description of the Related Art

Recently, wireless LANs have been installed in corporations so as to connect stations of cooperate members, such as personal computers (PCs), on the wireless LANs, and data can be transmitted and received among the stations. A typical example of the frame formats used for the wireless LANs is a frame format defined by the IEEE802.11b standard.

FIGS. 4A and 4B are diagrams of the structure of the frame format defined by the IEEE802.11b standard. First, this structure will be described.

The frame format used for a wireless LAN includes the two types of formats, namely, a long frame format shown in FIG. 4A and a short frame format shown in FIG. 4B. Both formats can be used for a wireless LAN. As shown in FIGS. 4A and 4B, a frame signal PPDU (PLCP Protocol Data Unit) for both formats, which is a protocol data unit handled by the PLCP (Physical Layer Convergence Protocol), consists of a PLCP preamble section, a PLCP header section, and a PSDU (PLCP Service Data Unit) section. The PLCP preamble section includes a signal for a station to detect an incoming frame signal and synchronize with the signal. The PLCP header section includes information, such as the signal speed and the packet length. The PSDU section is a unit of PLCP service data and includes an address indicating a station on the other end and transmitted content data.

In such a structure, the long frame format has a long preamble consisting of the PLCP preamble section and the PLCP header section, totaling 192 μs in length, while the short frame format has a short preamble consisting of the PLCP preamble section and the PLCP header section, totaling 96 μs in length. The long frame format was first defined and then the short frame format was defined to improve the transmission speed.

As described above, a frame format used for a wireless LAN includes two types, that is, a long frame format and a short frame format. However, some stations for a wireless LAN support only a long frame format and others support both a long frame format and a short frame format. That is, the stations that support only a long frame format cannot recognize a short frame format.

On the other hand, in ad hoc communications where a plurality of stations form a wireless LAN network and two of the stations communicate with each other, two stations use either long frame format or short frame format to communicate with each other. If stations supporting different frame formats exist on the network, two stations possibly cannot communicate with each other.

FIGS. 5A, 5B, and 5C are diagrams explaining a known connection method between stations when stations supporting different frame formats exist on the same network. The method will be described next. This example describes an unsuccessful connection between stations in the known method.

In general, when two stations carry out ad hoc communication over a wireless LAN, one station functions as a “parent” to notify the other station of the initiation of communication. Upon receiving a response to the initiation notification from the other station, the communication channel is established. Thereafter, the stations carry out communication therebetween to transmit and receive data.

As shown in FIG. 5A, a station STA1 that supports both a long frame format and a short frame format becomes the parent to communicate with a station STA2 that supports only a long frame format. In this case, the parent station STA1 transmits data in a short frame format having a short preamble to initiate communication with the station STA2 and waits for a response from the station STA2. However, since the station STA2 supports only a long frame format, the station STA2 cannot recognize the short frame format from the station STA1 and never responds to the station STA1. Therefore, the communication is not initiated.

On the other hand, as shown in FIG. 5B, since the station STA2 cannot recognize a call from the station STA1, the station STA2 becomes the parent and transmits data in a long frame format having a long preamble to initiate communication with the station STA1 and then waits for a response from the station STA1. In this case, since the station STA1 supports a long frame format, the station STA1 can recognize the frame. However, the station STA1 is the parent and is calling for the station STA2. The station STA1 considers the frame as one coming from another network and, therefore, does not respond to the frame. Accordingly, the communication is also not initiated.

Subsequently, as shown in FIG. 5C, the station STA1 attempts to transmit data in a short frame format having a short preamble to initiate communication with the station STA2 while being the parent. As a result, the communication cannot be initiated.

For example, Japanese Unexamined Patent Application Publication No. 2002-541725 discloses a communication technology using a long frame format and a short frame format.

As described above, according to the known technology, a connection method between stations cannot connect to each other if a station that supports a long frame format and a station that supports a short frame format are mixed within the network. Consequently, there is a possibility of being unable to communicate with each other, which is a problem.

### SUMMARY OF THE INVENTION

Accordingly, it is an object of the present invention to provide a connection method that allows stations to communicate with each other in a wireless network even when the stations support different frame formats.

According to the present invention, a connection method establishes connection between a first station and a second station in a wireless network using frame formats having different lengths. The first station supports both a long frame format and a short frame format, while the second station supports only a long frame format. The method includes the steps of causing the first station to be a parent station for using two channels and transmitting, from the first station to the second station, data in the short frame format over one channel and transmitting data in the long frame format over the other channel so as to establish a connection with the second station.

According to the present invention, a connection method establishes connection between a first station and a second station in a wireless network using frame formats having different lengths. The first station supports both a long frame format and a short frame format, while the second station supporting only a long frame format. The method includes the steps of causing the first station to be a parent station and transmitting, from the first station to the second station, data in the short frame format for a predetermined time period and thereafter transmitting data in a long frame format for a predetermined time period so as to establish a connection with the second station.

According to the present invention, a connection method establishes connection between a first station and a second station in a wireless network using frame formats having different lengths. The first station supports both a long frame format and a short frame format, while the second station supports only a long frame format. The method includes the steps of causing the first station to be a parent station; transmitting, from the first station to the second station, data in the short frame format for a predetermined time period; when the connection is unsuccessful, causing the first station to relinquish its role as the parent station so as to change to a listening mode; causing the second station to be a parent station; and transmitting, from the second station to the first station, data in the long frame format having a long preamble so as to establish a connection with the first station.

As described above, according to the present invention, even when stations that support only a long frame format and stations that support both a long frame format and a short frame format form a wireless network, the stations which support different frame formats can establish a connection therebetween to communicate with each other.

### BRIEF DESCRIPTION OF THE DRAWINGS

FIGS. 1A and 1B are diagrams explaining a connection method between stations in a wireless network according to a first embodiment of the present invention;

FIGS. 2A and 2B are diagrams explaining a connection method between stations in a wireless network according to a second embodiment of the present invention;

FIGS. 3A through 3D are diagrams explaining a connection method between stations in a wireless network according to a third embodiment of the present invention;

FIGS. 4A and 4B illustrate frame formats defined by the IEEE802.11b standard; and

FIGS. 5A, 5B, and 5C are diagrams explaining a known connection method for stations to communicate with each other in a wireless network when the stations support different frame formats.

### DESCRIPTION OF THE PREFERRED EMBODIMENTS

Embodiments of a connection method between stations in a wireless network according to the present invention will be described below in detail with reference to the accompanying drawings.

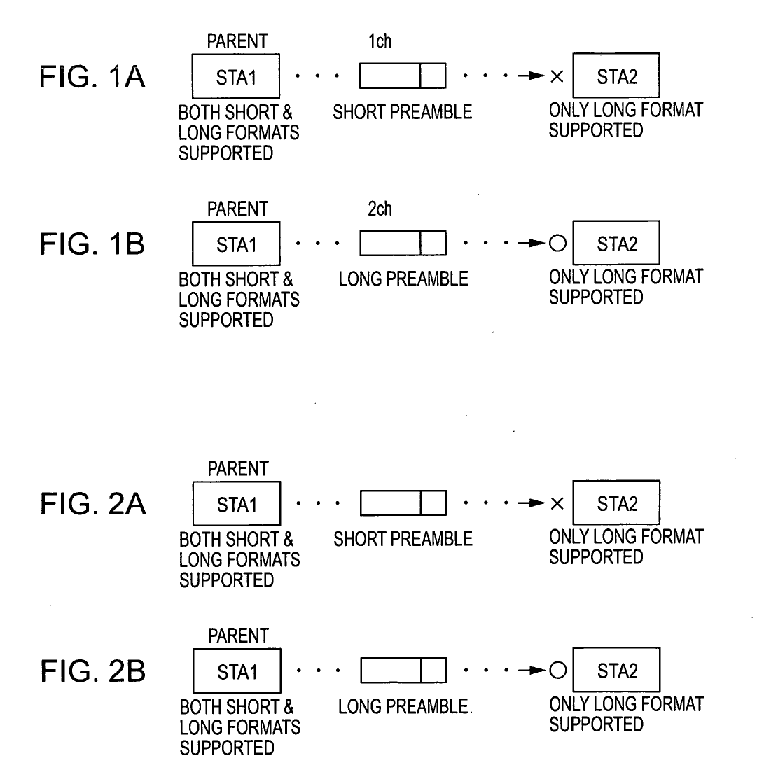

FIGS. 1A and 1B are diagrams explaining a connection method between stations in a wireless network according to a first embodiment of the present invention. In the first embodiment of the present invention, a station that supports both a long frame format and a short frame format becomes the parent and uses two channels. The station transmits data in the short frame format over one channel and transmits data in the long frame format over the other channel so as to establish a connection with a station that supports only a long frame format.

Like the example of the known technology shown in FIGS. 5A through 5C, in an example shown in FIG. 1A, a station STA1 that supports both a long frame format and a short frame format becomes the parent and attempts to communicate with a station STA2 that supports only a long frame format. At that time, the parent station STA1 transmits data in a short frame format having a short preamble using one of the two channels to initiate communication with the station STA2 and waits for a response from the station STA2. However, since the station STA2 supports only a long frame format, the station STA2 cannot recognize the data in the short frame format from the station STA1 and never responds to the station STA1. Therefore, the communication is not initiated.

Thereafter, the parent station STA1 changes the channel to the other channel and transmit data in the long frame format having a long preamble using that channel to initiate communication with the station STA2 and waits for a response from the station STA2. Since the station STA2 supports only a long frame format, the station STA2 can recognize the data in the long frame format from the station STA1 and responds to the station STA1. Thus, the connection between the stations STA1 and STA2 is established, and the communication can be initiated (refer to FIG. 1B).

As noted, according to the first embodiment of the present invention, the station that supports both a long frame format and a short frame format becomes the parent and transmits data in the long frame format and data in the short frame format by using two channels. Accordingly, a connection between the stations that support different frame formats can be established.

FIGS. 2A and 2B are diagrams explaining a connection method between stations in a wireless network according to a second embodiment of the present invention. In the second embodiment of the present invention, a station that supports both a long frame format and a short frame format becomes the parent. First, the station transmits data in the short frame format. If the station does not receive a response from the other station, the station then transmits data in the long frame format in order to establish a connection with the other station that supports only a long frame format.

Like the example of the known technology shown in FIGS. 5A through 5C, in an example shown in FIGS. 2A and 2B, a station STA1 that supports both a long frame format and a short frame format becomes the parent and attempts to communicate with a station STA2 that supports only a long frame format. At that time, the parent station STA1 first transmits data in a short frame format having a short preamble to initiate communication with the station STA2 and waits for a response from the station STA2. However, since the station STA2 supports only a long frame format, the station STA2 cannot recognize the data in the short frame format from the station STA1 and never responds to the station STA1. Therefore, the communication is not initiated (refer to FIG. 2A).

If the parent station STA1 does not receive the response within a predetermined time period, the station STA1 transmits data in the long frame format having a long preamble to initiate a communication with the station STA2 and waits for the response. Since the station STA2 supports only a long frame format, the station STA2 can recognize the data in the long frame format from the station STA1 and responds to the station STA1. Therefore, the connection between the stations STA1 and STA2 is established, and the communication can be initiated (refer to FIG. 2B).

As noted, according to the second embodiment of the present invention, the station that supports both a long frame format and a short frame format becomes the parent and transmits data in the short frame format and data in the long frame format at different times. Accordingly, a connection between stations that support different frame formats can be established.

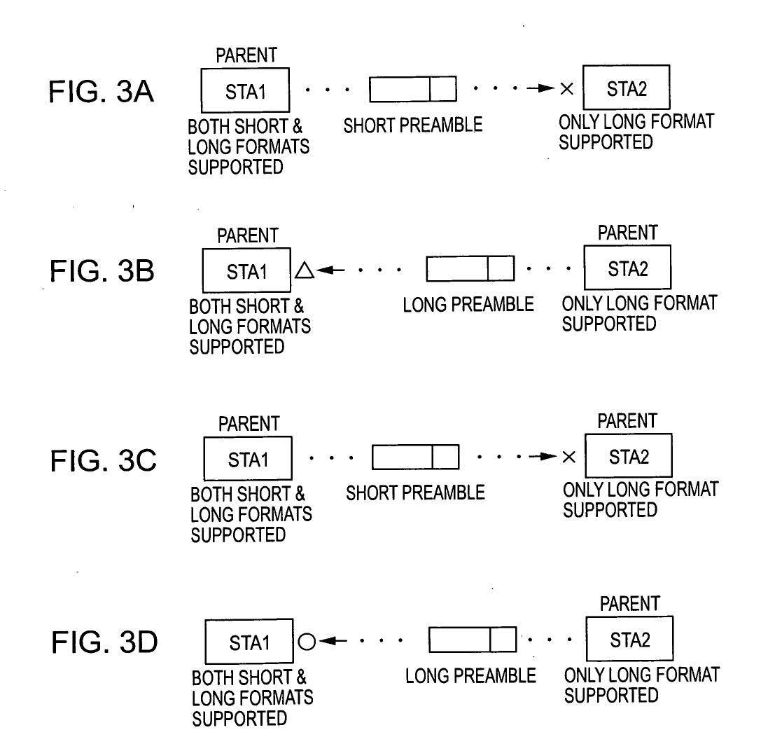

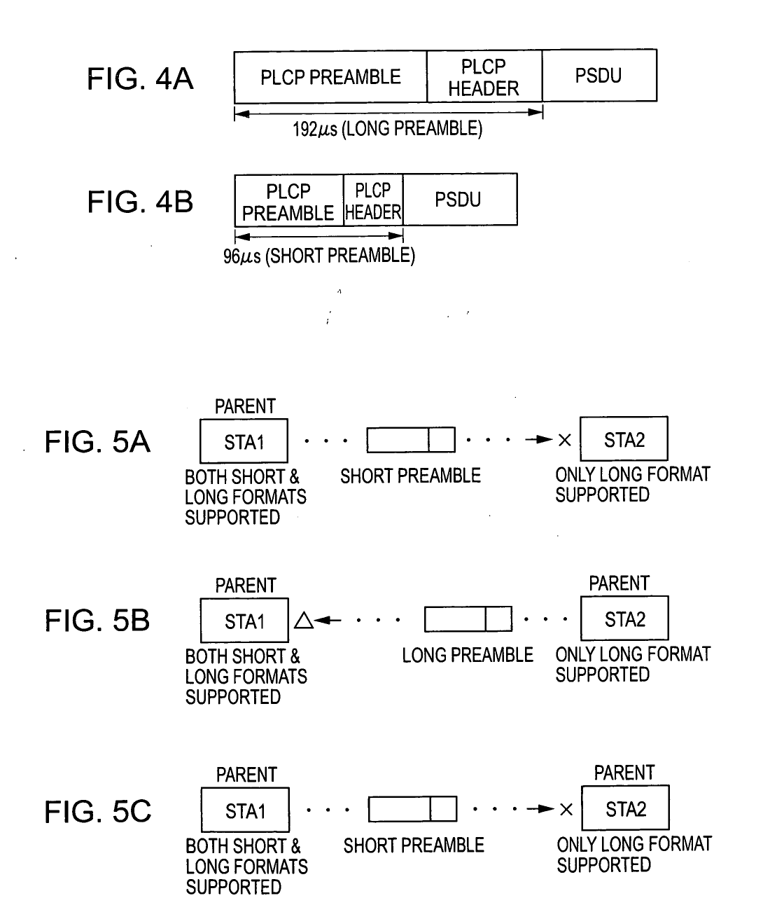

FIGS. 3A through 3D are diagrams explaining a connection method between stations in a wireless network according to a third embodiment of the present invention. In the third embodiment of the present invention, a station that supports both a long frame format and a short frame format becomes the parent. First, the station transmits data in the short frame format. If the station does not receive a response, a station that supports only a long frame format then becomes the parent in order to establish a connection.

Like the example of the known technology shown in FIGS. 5A through 5C, in an example shown in FIGS. 3A through 3D, a station STA1 that supports both a long frame format and a short frame format becomes the parent and attempts to communicate with a station STA2 that supports only a long frame format. At that time, the parent station STA1 first transmits data in a short frame format having a short preamble to initiate communication with the station STA2 and waits for a response from the station STA2. However, since the station STA2 supports only a long frame format, the station STA2 cannot recognize the data in the short frame format from the station STA1 and never responds to the station STA1. Therefore, the communication is not initiated (refer to FIG. 3A).

On the other hand, since the station STA2 cannot recognize a call from the station STA1, the station STA2 becomes the parent and transmits data in a long frame format having a long preamble to initiate communication with the station STA1 and waits for a response from the station STA1. At that time, the station STA1 can recognize the frame. However, since the station STA1 transmits a call while being the parent, the station STA1 considers the frame as one from another network and, thus, never responds to the frame. Therefore, the communication is not initiated (refer to FIG. 3B).

Thereafter, while being the parent, the station STA1 transmits data in a short frame format having a short preamble in order to initiate communication with the station STA2. However, the communication cannot be initiated (refer to FIG. 3C).

Since the station STA1 cannot establish a network when being the parent, the station STA1 relinquishes its role as a parent and changes to a listening mode. On the other hand, the station STA2 becomes the parent again and transmits data in a long frame format having a long preamble to initiate communication with the station STA1 and waits for a response from the station STA1. In this case, since the station STA1 also supports a long frame format, the station STA1 can recognize the data in the long frame format from the station STA2 and responds to the station STA2. Therefore, the connection between the stations STA1 and STA2 can be established and the communication can be initiated (refer to FIG. 3D).

As noted, according to the third embodiment of the present invention, if the station that supports both a long frame format and a short frame format becomes the parent and cannot establish a connection, the station relinquishes its role as the parent. On the other hand, the station that supports only a long frame format attempts to establish the connection. Accordingly, a connection between the stations that support different frame formats can be established.

1. A connection method for establishing connection between a first station and a second station in a wireless network using different frame formats, the first station supporting both a first frame format and a second frame format, the second station supporting only the first frame format, the method comprising the steps of:
causing the first station to be a parent station for using two channels; and
transmitting, from the first station to the second station, data in the first frame format over one channel and transmitting data in the second frame format over the other channel so as to establish a connection with the second station.

2. A connection method for establishing connection between a first station and a second station in a wireless network using different frame formats, the first station supporting both a first frame format and a second frame format, the second station supporting only the first frame format, the method comprising the steps of:
causing the first station to be a parent station; and
transmitting, from the first station to the second station, data in the second frame format for a predetermined time period and thereafter transmitting data in the first frame format so as to establish a connection with the second station.

3. A connection method for establishing connection between a first station and a second station in a wireless network using different frame formats, the first station supporting both a first frame format and a second frame format, the second station supporting only the first frame format, the method comprising the steps of:
causing the first station to be a parent station;
transmitting, from the first station to the second station, data in the first frame format for a predetermined time period;
if the connection is unsuccessful, causing the first station to relinquish its role as the parent station so as to change to a listening mode;
causing the second station to be a parent station; and
transmitting, from the second station to the first station, data in the second frame format so as to establish a connection with the first station.

4. A connection method according to claim 1 wherein the frame formats are of different lengths and wherein the first frame format is a short frame format and the second frame format is a long frame format.

5. A connection method according to claim 2 wherein the different frame formats have different lengths and wherein the first frame format is a long frame format and the second frame format is a short frame format.

6. A connection method according to claim 3 wherein the different frame formats have different lengths and wherein the firs frame format is a short frame format and the second frame format is a long frame format.

7. A wireless network comprising a first station configured to support both a first frame format and a second frame format and a second station configured to support only one of said long or short frame formats the first station being further configured to be a parent station having two data channels such that the first station can transmit to the second station data in the first frame format over one channel and data in the second frame format over the other data channel so as to establish a connection with the second station.

8. A wireless network according to claim 7 wherein the first and second stations comprise PCs.

9. A wireless network according to claim 8 wherein the first frame format is a long frame format and the second frame format is a short frame format.
